(19) United States
(12) Patent Application Publication
(10) Pub. No.: US 2015/0319595 A1
(43) Pub. Date: Nov. 5, 2015

(54) DEVICE-TO-DEVICE COMMUNICATION SETUP USING PROXIMITY SERVICES

(71) Applicant: RENESAS MOBILE CORPORATION, Tokyo (JP)

(72) Inventors: Sami-Jukka HAKOLA, Kempele (FI); Samuli TURTINEN, Ii (FI); Timo Kalevi KOSKELA, Oulu (FI)

(73) Assignee: RENESAS MOBILE CORPORATION, Chiyoda-Ku, Tokyo (JP)

(21) Appl. No.: 14/440,193

(22) PCT Filed: Nov. 1, 2013
(86) PCT No.: PCT/IB2013/059842

§ 371 Date: May 1, 2015

(30) Foreign Application Priority Data
Nov. 2, 2012 (GB) 1219786.9

(51) Int. Cl. H04W 8/00; H04W 76/02

(52) U.S. Cl. CPC H04W 8/005; H04W 76/023; H04W 84/042

(57) ABSTRACT

A communications method for facilitating peer discovery, and thereby facilitating peer-to-peer communications in a mobile communications network, comprises: acquiring, by a user equipment capable of performing peer-to-peer, P2P, proximity services, a link-local interface identifier from a node of a network. The link-local interface identifier is unique within the network, and the method further comprises establishing a link-local domain with at least one other user equipment in the network at least partly on the basis of the acquired link-local interface identifier.

### TECHNICAL FIELD

The invention relates generally to mobile communications networks. More particularly, although not exclusively, the invention relates to peer discovery by applying application layer protocols on link-local domain and to enabling peer-to-peer communications based thereon.

### BACKGROUND

It is foreseen that user terminals carried by users may apply proximity services (ProSe), such as direct device-to-device, (D2D) communication, or apply the functionalities of a common application. In order to enable such proximity services to take place, a peer discovery is needed. The peer discovery may denote discovering another device in proximity or discovering an application running in a device in the proximity, for example.

### SUMMARY

According to an aspect of the invention, there is provided a method for enabling peer discovery in a mobile communications network, comprising: detecting, by a node of a network, that a user equipment connected to the network is capable of performing peer-to-peer (P2P) proximity services; determining a link-local interface identifier to be assigned to the detected user equipment, wherein the determined link-local interface identifier is unique within the network; and causing an indication of the assigned link-local interface identifier to the detected user equipment in order to enable the user equipment to establish a link-local domain with at least one other user equipment in the network.

According to an aspect of the invention, there is provided a method for enabling P2P communications in a mobile communications network, comprising: acquiring, by a user equipment capable of performing P2P proximity services, a link-local interface identifier from a node of a network, wherein the link-local interface identifier is unique within the network; and establishing a link-local domain with at least one other user equipment in the network at least partly on the basis of the acquired link-local interface identifier.

According to an aspect of the invention, there is provided a method for enabling P2P communications in a mobile communications network, comprising: detecting, by a user equipment capable of performing P2P proximity services, a link-local P2P discovery message sent by another user equipment, wherein the link-local P2P discovery message is at least partly based on an application layer discovery protocol; and detecting a link-local interface identifier included in the link-local P2P discovery message, wherein the link-local interface identifier is unique within a serving network.

According to an aspect of the invention, there is provided an apparatus, comprising: means to detect that a user equipment connected to a network is capable to of performing peer-to-peer, P2P, proximity services; means to determine a link-local interface identifier to be assigned to the detected user equipment, wherein the determined link-local interface identifier is unique within the network; and means to cause an indication of the assigned link-local interface identifier to the detected user equipment in order to enable the user equipment to establish a link-local domain with at least one other user equipment in the network.

According to an aspect of the invention, there is provided an apparatus, comprising: means to cause a user equipment capable of performing peer-to-peer, P2P, proximity services to acquire a link-local interface identifier from a node of a network, wherein the link-local interface identifier is unique within the network; and means to establish a link-local domain with at least one other user equipment in the network at least partly on the basis of the acquired link-local interface identifier.

According to an aspect of the invention, there is provided an apparatus, comprising: means to cause a user equipment capable of performing peer-to-peer, P2P, proximity services to detect a link-local P2P discovery message sent by another user equipment, wherein the link-local P2P discovery message is at least partly based on an application layer discovery protocol; and means to detect a link-local interface identifier included in the link-local P2P discovery message, wherein the link-local interface identifier is unique within a serving network.

According to an aspect of the invention, there is provided an apparatus, comprising processing means configured to cause the apparatus to perform the method according to the above aspects.

According to an aspect of the invention, there is provided a computer program product embodied on a distribution medium readable by a computer and comprising program instructions which, when loaded into an apparatus, execute the method according to the above aspects.

Embodiments of the invention are defined in the dependent claims.

### BRIEF DESCRIPTION OF DRAWINGS

In the following, the invention will be described in greater detail with reference to exemplary embodiments of the invention and the accompanying drawings, in which:

FIG. 1 is a schematic diagram of a network to which the embodiments are applicable;

FIG. 2 is a block diagram that illustrates a format for an internet protocol version 6 address;

FIG. 3 is a schematic diagram of a network according to an embodiment;

FIGS. 4, 5A, 5B, and 6 are flow diagrams that illustrate methods according to some embodiments

FIG. 7 is a schematic block diagram that depicts a protocol stack of a user equipment, according to an embodiment;

FIG. 8 is a signaling flow diagram according to an embodiment;

FIG. 9 is a schematic block diagram that illustrates a communication scenario according to an embodiment; and

FIGS. 10, 11 and 12 are schematic block diagrams depicting apparatuses according to some embodiments.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The embodiments of the invention are applicable to a plurality of communication networks regardless of the applied radio access technology. For example, at least one of the following radio access technologies (RATs) may be applied: Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), long term evolution (LTE), and/or LTE advanced (LTE-A). The present embodiments are not, however, limited to these protocols. Typically the communication network comprises base stations, such as an evolved node B (eNB), capable of controlling radio communication and managing radio resources.

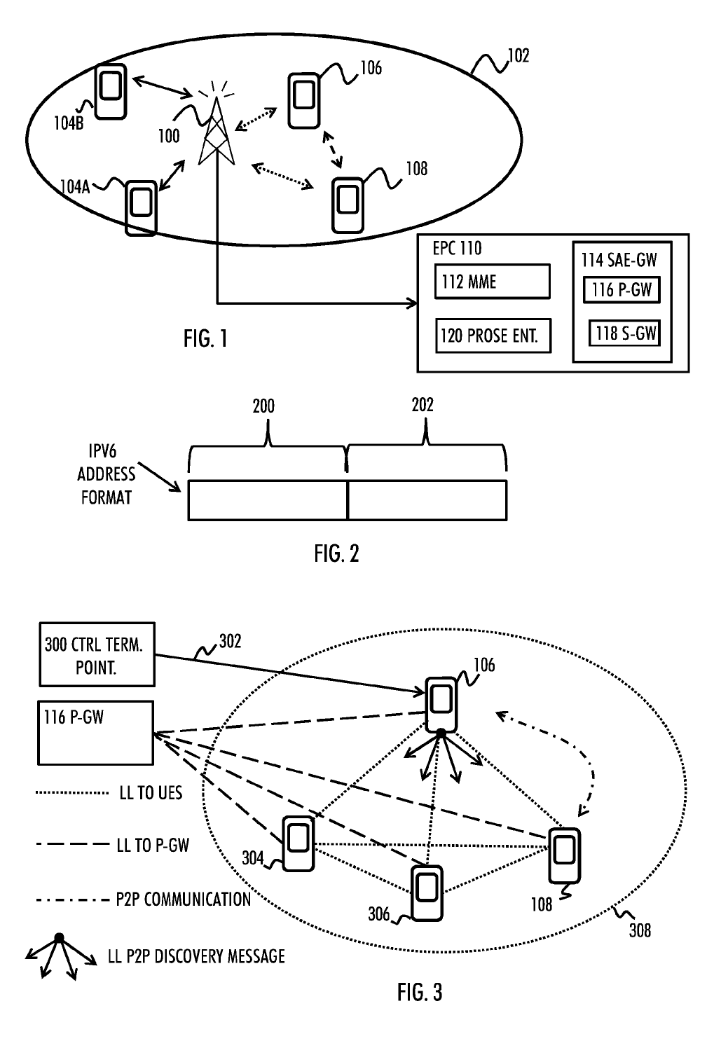

FIG. 1 shows a communication network where embodiments of the invention may be applicable. An eNB 100 may be used in order to provide radio coverage to the cell 100, for example. In the case of multiple eNBs in the communication network, the eNBs may be connected to each other with an X2 interface, as specified in the LTE. The eNB 100 may be further connected via an Si interface to an evolved packet core (EPC) 110, more specifically to a mobility management entity (MME) 112 and to a system architecture evolution gateway (SAE-GW) 114. The MME 112 is a control plane node for controlling functions of non-access stratum signaling, roaming, authentication, tracking area list management, etc. The MME 112 together with a service GPRS (general packet radio service) support node (SGSN), which is not shown, may provide the control plane function for mobility between the LTE and the 2G/3G access networks.

The SAE-GW 114 may comprise a packet data network gateway (P-GW) 116 and a service gateway (S-GW) 118. The P-GW 116 may provide connectivity from terminal devices to external packet data networks by being the point of exit and entry of user traffic for the UE. The S-GW 118 routes and forwards user data packets, while also acting as the mobility anchor for the user plane during inter-eNB handovers and as the anchor for mobility between the LTE and other 3GPP technologies. S-GW 118 may also terminate the downlink data path for idle state UEs and trigger paging when downlink data arrives for the idle UE.

Still referring to FIG. 1, the eNB 100 may control cellular radio communication links established between the eNB 100 and each of terminal devices 104A and 104B located within the cell 102. These communication links marked with solid arrows may be referred as conventional communication links. The terminal device may be a terminal device of a cellular communication system, e.g. a computer (PC), a sensor, a laptop, a mobile phone, a cellular phone, or any other user terminal (UT) or user equipment (UE) capable of communicating with the cellular communication network. In addition to or instead of conventional communication links, direct peer-to-peer (P2P), also known as mobile-to-mobile (M2M), terminal-to-terminal (T2T), D2D, connections may be established among terminal devices, such as terminal devices 106 and 108. The devices (or mobile or terminals or peers or machines) 106 and 108 having a direct physical communication link may utilize the radio resources of the cellular network, thus sharing the cellular network resources of the licensed band with other devices 104A, 104B having the conventional cellular communication to the eNB 102.

Such direct D2D communication may be applied for example in ProSe. The applied P2P (D2D) communication may refer to dedicated P2P communication links between devices or to multicast/broadcast P2P communication between one transmitter and at least one recipient without establishment of dedicated links. Another exemplary use case may be the use of a same application, such as a peer-to-peer application, by the devices 106, 108. When being in proximity of each other, it may make sense to apply a direct P2P link as shown with the dashed bi-directional arrow in FIG. 1 instead of the conventional link.

In general, the ProSe may be seen to comprise two main building blocks: peer discovery and direct P2P communication. The peer discovery may mean finding other interesting peers in the proximity, wherein the peer may denote applications, users, devices, services, ProSe capable UEs, etc. Therefore, prior to applying direct communication with another UE in proximity, the devices 106, 108 and/or the applications running on the devices 106 and 108 may need to be discovered. The device/peer discovery may be implemented on a radio layer, also known as a physical layer or communication layer, either by using direct radio discovery signals between the devices or by the network facilitating the discovery. The P2P communication, on the other hand, may denote a communication between two ProSe capable/enabled UEs (i.e. ProSe UEs) in proximity by means of a communication path established between the UEs. The communication path may be, for example, established directly between the ProSe enabled UEs or routed via local eNB(s). A ProSe enabled UE may denote a UE that supports the ProSe discovery and/or the ProSe communication.

In addition to the typical peer discovery (also called P2P discovery or ProSe discovery), it may provide some advantages if the peer discovery functionalities of the LTE would allow an existing application layer (service/peer) discovery protocol (ALDP) to be utilized. These existing ALDPs comprise, for example, a Service Location Protocol (SLP), a Service Discovery Protocol (SDP), a Simple Service Discovery Protocol (SSDP) and a Universal Plug and Play (UPnP). However, these protocols may require a so called link-local domain or a local link to be established in the LTE between the UEs. That is, they may be based on a link-local domain multicast addressing between UEs. A node's local link, or a link-local network, includes itself and other nodes that may exchange packets without internet protocol (IP) header data being modified. In practice, this includes all nodes not separated by a router. In other words, such node may be looked up using an IP multicast query on the link-local IP network. It should be noted that the link-local domain identifiers (ID) may not be globally unique.

As explained, there may be some benefits in using the existing ALDPs in the LTE. However, currently these may not be implemented upon the LTE for the proximity based peer discovery because the current LTE link-local domain does not exist between two UEs. The current 3GPP link-local model includes a link layer point-to-point link only between the UE, such as the UE 106, and the P-GW 116. In other words, the current link-local domain of the LTE comprises only the UE 106 and the P-GW 116, and there is no link-local domain among the UEs 106, 108, even if they are close to each other (i.e. in proximity of each other).

Moreover, current art applies the Internet protocol version 6 (IPv6) address which is a numerical label that is typically used to identify a network interface of a computer or other network node participating in an IPv6-enabled computer network. However, these IPv6 addresses may not be used by the ALDPs in the proximity based peer discovery multicasting for the following reasons. As shown in FIG. 2, the 128 bit long IPv6 IP address typically comprises two parts 200 and 202, each with 64 bits: a network prefix 200 used for routing and an interface identifier (IID) 202 used to identify a host's network interface. However, when the IPv6 address is used for multicasting, which would be the case when applying such application layer discovery protocols, the otherwise globally unique prefix 200 is replaced with a different, non-unique format.

This is to make the prefix 200 the same for all link-local addresses. Likewise, the IID 202 of the IPv6 address may not provide a unique manner for identifying a certain UE in proximity either. This is because the IID 202 is assigned to the UE by the P-GW 116, which only ensures that the IID of the P-GW 116 and of the given UE are not the same. Thus, it is not guaranteed that they would be unique within the multicast group of ProSe discovery protocol.

Therefore, it is proposed to generate a link-local domain for the ProSe-enabled UEs among UEs in proximity of each other for user plane connections. Such generation of the ProSe link-local domain may allow for example the utilization of the existing ALDPs for the peer discovery multicasting, as indicated above.

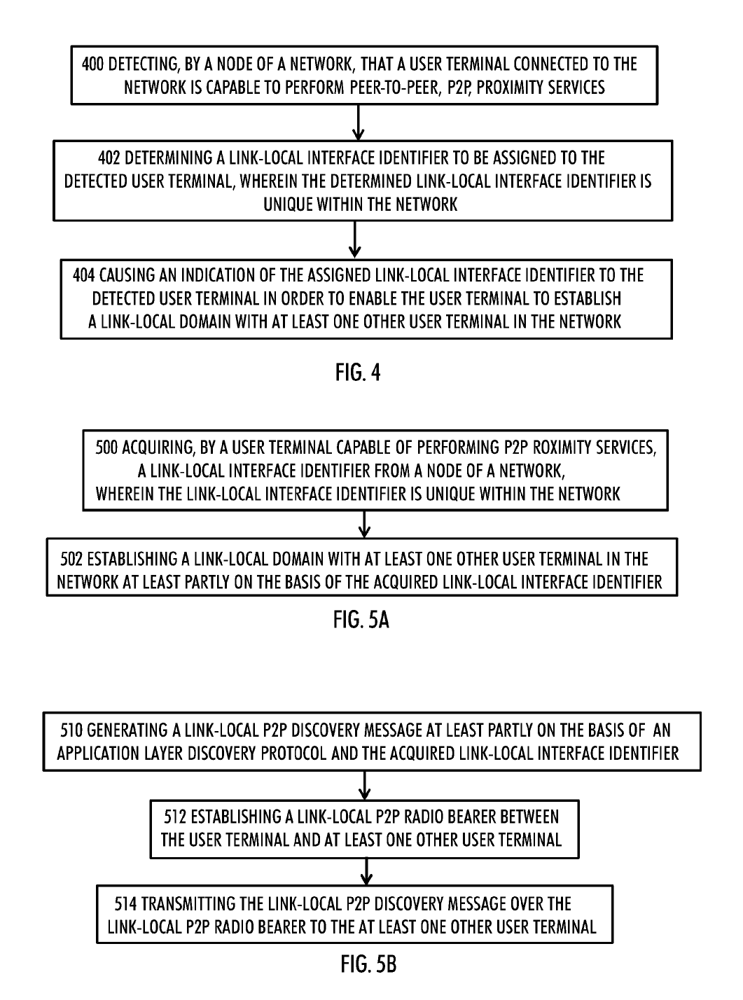

Thus, as shown in FIGS. 3 to 4, it is proposed that a node of a network detects, in step 400, that a user equipment (i.e. a user terminal), such as the UE 106, connected to the network is capable of performing the P2P proximity services. The UE 106 may be able to communicate over the P2P communication connection or send/detect P2P discovery messages, for example. The detection may be based on an indication of the presence of the UE 106 from another network node (such as from the eNB 100) or the node may itself detect the presence and capabilities of the UE 106 within the network. For example, in an embodiment, the node obtains an indication from the UE 106 in which the UE 106 indicates the capability to perform the P2P based ProSe. The UE 106 may, for example, request activation of ProSe services in the network. The ProSe services provided by the network may comprise the network node informing the to-be-used P2P discovery channel and allocating resources for the P2P discovery channel.

As shown in FIG. 3, the node may be, in an embodiment, a control plane termination node 300 of the network, such as a ProSe entity 120 of the network, the MME 112 of the network. The ProSe entity 120 may be responsible for the activation and application of ProSe functionalities in the network. In an embodiment, the node is not the packet data network gateway 116. For the following description, let us assume that the node is the control plane termination point 300.

In an embodiment, the network is a specific public land mobile network, PLMN. A given PLMN may be distinguished from another PLMN by the operator providing the given PLMN, for example. That is, different networks may be provided by different operators. In an embodiment, the network may be distinguished from another network by the RAT of the network (such as the 2G, the 3G, and the LTE/4G). For the following description, let us assume that the network is represented with a reference numeral 308 in FIG. 3. In an embodiment, the network may comprise a plurality of cells, such as the cell 102 and other cells. A given UE, such as the UE 106, may be located within a cell 102 of the network 308 and served by the corresponding eNB 100. Further, the eNB 100 may be connected to the EPC 110 comprising the P-GW 16 and the control plane termination point 300, such as the MME 112 or the ProSe entity 120, as illustrated in FIG. 1.

It is further proposed that, in step 402, the node 300 determines a link-local (LL) interface identifier (IID) to be assigned to the detected UE 108, wherein the link-local IID is unique within the network. The link-local IID may also be called a link-local domain IID. In an embodiment, the link-local IID may be a sequence of bits for example, similar to the IID of the IPv6 address. However, in another embodiment, the link-local IID need not follow the format of the IPv6 address. In an embodiment, the link-local IID is a different identifier as the IPv6 IID.

In an embodiment, the to-be-assigned link-local IID is unique within the network 308, such as within the serving PLMN. Thus, each of the UEs 106, 108, 304, 306 in the network 308 that is assigned with such link-local IID, has a unique link-local IID. That is, within the network 308 there are no two link-local IIDs which would be the same. In other words, the node 300 makes sure that it does not allocate two link-local IID of the same kind When the ProSe UE 106 is roaming to another (LTE) network providing ProSe services but operated by another PLMN operator, the target network may need to assign a new link-local IID that is unique within the target network. The determination may be based on arbitrary selection by taking into account the limitation that each assigned link-local HD must be unique in the network.

In yet one an embodiment, the link-local IID is, in addition to being unique within the network 308, globally unique. In such embodiment, the above mentioned roaming example may not require a new assignment of a new link-local IID.

Upon having decided on the link-local IID for the UE 108, the node 300 may, in step 404, cause an indication 302 of the link-local IID to the detected UE 106. This may be in order to allow the UE 106 to set-up or establish the link-local domain with at least one other UE in the network 308 at least partly on the basis of the indicated link-local IID. In the link-local domain, user plane communication between link-local nodes (i.e. UEs in this case) may take place without routing (e.g. directly or via a local eNB). The establishment of such link-local domain between the UEs in proximity may comprise the UE 106 transmitting the acquired link-local IID to the other UE(s), as will be described later. The at least one other UE may comprise, for example, the UEs 108, 304, and 306 of FIG. 3. Further, the link-local HD may be used in multicasting a link-local P2P discovery message to the at least one other UE 108, 304, and 306 in proximity, or in performing link-local domain communication between UEs 106, 108, 304, and 306.

The indication of the link-local HD from the network 308 to the UE 106 may be performed in one of the following ways: as a separate signaling during the attach procedure of the UE 106 to the network 308, as a separate signaling after the attach procedure of the UE 106 to the network 308, as an additional signaling during a handover of the UE 106 from the network 308 to another (target) network. For example, the node 300 may indicate via the corresponding eNB the link-local IID to the UE 106 during an intra-3GPP inter-RAT handover. The handover may be, for example, from the GERAN or from the UTRAN to the LTE network which may provide ProSe. Alternatively, the link-local HD may be indicated when the UE 106 has requested to activate the ProSe in the network 308/cell 102.

Let us take a look at the proposal from the point of view of the UE 106 capable of performing the P2P proximity services with reference to FIG. 5A. In step 500, the UE 106 acquires the link-local IID from the node, such as the control plane termination node 300, of the network 308. As explained, the link-local IID is unique at least within the network 308 which assigned the link-local IID.

Thereafter, the UE 106 may in step 502 establish the link-local domain with at least one other UE 106, 304, 306 in the network 308 at least partly on the basis of the acquired link-local HD. As said, this may comprise multicasting/unicasting of the link-local IID to the UEs in proximity. Let us take a look at this further.

In an embodiment, the establishment of the link-local domain between the UEs 106, 108, 304, 306 may comprise what is shown in FIG. 5B. In step 510, UE 106 (or any of the UEs acquiring the link-local IID) may generate a link-local P2P discovery message at least partly on the basis of an application layer discovery protocol and the acquired link-local interface identifier. As explained earlier, the ALDPs may require the use of link-local domain for the discovery process. Now that the UE 106 acquires such unique link-local IID, the UE 106 may generate the link-local domain P2P discovery message based on the ALDP. Thus, the existing ALDPs may advantageously be taken into use in the ProSe P2P discovery process between the UEs 106, 108, 304, and 306 in the link layer. Without the allocation of the unique link-local IID, such application of the ALDP in the discovery of the ProSe UEs would not be possible.

In an embodiment, the UE 106 may include the acquired link-local IID to the generated link-local P2P discovery message as a source address. Then each UE receiving the link-local P2P discovery message may acquire knowledge that the transmitting UE 106 is in proximity, as will be described later.

In a further embodiment, the UE 106 may determine a link-local address of the UE 106 at least partly on the basis of the acquired link-local IID. E.g. the address may be of the same format as the IPv6 interface ID. Then the UE 106 may, as explained, include the determined link-local address to the generated link-local P2P discovery message as the source address.

In an embodiment, the UE 106 may replace the IPv6 IID of the UE 106 with the acquired link-local interface identifier. Thus, the UE 106 may then apply the modified IPv6 address in the link-local P2P discovery message.

In another embodiment, the IPv6 address of the UE 106, which is used for cellular radio bearers, is not replaced with the acquired link-local IID. Having a separate link-local interface identifier for the ProSe purposes and separate IPv6 address for cellular bearers may allow the UE 106 to use the existing methods with respect to the IPv6 address configuration. For example, with regards to privacy, the UE 106 may change the IPv6 interface identifier used to generate the full IPv6 address without involving the network 308, as specified in the LTE specifications.

In step 512, the UE 106 may further establish a link-local P2P radio bearer between the UE 106 and at least one other UE 108, 304, 306. This step may comprise initialization of the ProSe link-local (i.e. link layer) interface by using the assigned link-local domain interface identifier. Additionally, the UE 106 may perform control signaling with the network 308 in order to have the link-local P2P radio bearer initialized/established. The network 308 may, for example, allocate radio resources for such radio channel.

Now that the link-local P2P discovery message is generated and the link-local P2P radio bearer is set up, the UE 106 may in step 514 transmit the link-local P2P discovery message over the link-local P2P radio bearer to the at least one other UE 108, 304, 306, as shown in FIG. 3. This may be advantageous because then the other UEs 108, 304, 306 in proximity may detect the UE 106 on the basis of the link-local IID included in the link-local P2P discovery message. In an embodiment, the transmission may be a multicast. In such case the target address may be ff02::1. That is, it is targeted to all nodes on the local network segment (e.g. all UEs in proximity).

In an embodiment, the acquired link-local interface identifier is dedicated to be used by the UE 106 for the P2P proximity services, wherein the P2P proximity services comprise transmission of a P2P discovery message and/or performing a P2P communication with the at least one other UE. The node 300 may indicate this to the UE 106 when assigning the link-local HD to the UE. In an embodiment, the link-local IID is dedicated for the ProSe exclusively.

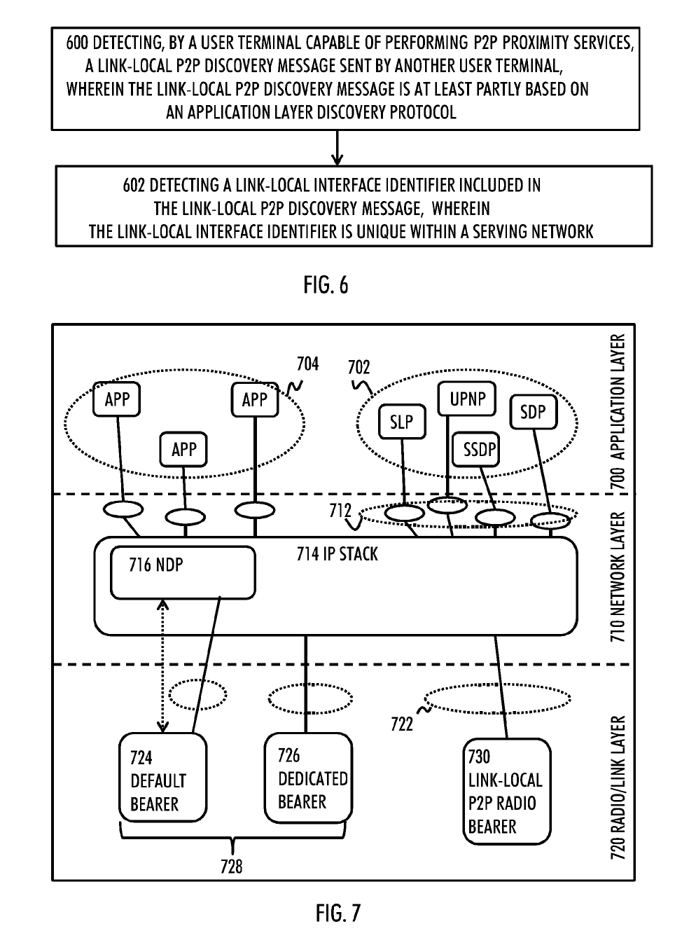

As shown in FIG. 6, the UE 108 may, in step 600, detect the link-local P2P discovery message sent by the UE 106, wherein the link-local P2P discovery message is at least partly based on an ALDP. The UE 108 may then, in step 602, detect the link-local IID included in the received link-local P2P discovery message. In an embodiment, the link-local IID is included in the discovery message as the source address of the UE 106. Alternatively, the link-local IID may be included in the discovery message as additional information. By detecting the link-local IID, the UE 108 may be able to identify the UE 106 in the network 308.

Further, in an embodiment, the UE 108 may then, for example, request a P2P communication connection to the UE 106 corresponding to the detected/discovered link-local HD and/or send a report to the network 308 which report indicates which UEs 106 (and possibly 304, 306) have been discovered to be in the proximity. Such direct communication may be advantageous so that the traffic load via the eNB 100 may be reduced. The report, on the other hand, may allow the network 308 to acquire knowledge of the UEs whereabouts and possibly allow the network 308 to set up direct connections between communicating UEs who are in proximity of each other in the network 308.

In an embodiment, after detecting the link-local IID in the link-local P2P discovery message, the UE 108 may generate an IPv6 message on the basis of the detected link-local interface identifier and a predetermined criterion, and process the generated IPv6 message on a higher application layer. Such generation may be based on a predetermined rule/criterion that the target address of the discovery message (e.g. ff02::1) is dedicated to correspond to a link layer P2P discovery message based on an application layer discovery protocol. This may be advantageous as then no other information in addition to the source address (e.g. the link-local IID) and target address (e.g. ff02::1) may need to be sent in the link-local P2P discovery messages transmitted over the air interface. For example, the transmitting UE 106 may perform header compression in order to remove the overhead of IP headers. For example, only the link-local IID may be left from the IP header after the compression. Then, the receiving UE 108 may make the inverse operation and construct the full IP packet to be delivered to higher (application) layers.

In an embodiment, the UE 106 may receive, in an embodiment, a request to establish a direct link-local P2P connection with the specific UE 108 which detected the link-local P2P discovery message sent (e.g. multicasted) by the UE 106. The UE 106 may then establish the link-local P2P connection to the specific UE 108. The step of establishing the communication connection may require control signaling from the eNB 100, for example. Such direct link-local P2P connection is depicted in FIG. 3 with the bi-directional dot-dashed arrow between the UEs 106 and 108. Then the UE 106 may transmit user data over the established link-local P2P connection to the specific UE 108. This may be advantageous so that the traffic load via the eNB 100 may be reduced.

As shown in FIG. 3 and explained above, owing to the established link-local domain, the UEs 106, 108, 304 and 306 may detect each other via the link-local connections shown with dotted lines between the UEs 106, 108, 304 and 306. It should be noted that in current art the UEs 106, 108, 304 and 306 only have link-local domain connection to the P-GW 116, as shown with dashed lines. Thus, the proposal may provide an additional dimension in the link-local scope of a given UE. It should be noted that although the description is described from the point of view of the UE 106 receiving the link-local IID, it should be noted that the node 300 may assign such link-local IID to the other UEs 108, 304 and 306, or to some of the other UEs, as well. Then, the link-local connections between the UEs 108, 306 and 308 may be used by the UEs 108, 306 and 308 in transmitting P2P discovery messages or for P2P communication, for example. Therefore, it is clear that the UEs 106, 108, 304, 306 may be able to build and apply the link-local domain between each other, wherein the link-local domain is set-up by using the assigned link-local IIDs given to the UEs 106, 108, 304, 306 in the network 308 and in proximity of each other.

Thus, the proposal may advantageously enable the UE 106 to utilize the existing application layer (service) discovery protocols, like internet engineering task force (IETF) defined SLP, SDP, SSDP, and UPnP, which may require the existence of the link-local domain. These ALDPs may be used by the UE 106 in the established link-local domain (in this context for the proximity based service/peer discovery) between different UEs in the network 308. This may provide an efficient utilization of proximity services (also known as local services) by the EPC attached LTE mobile phones, such as the UEs 106, 108, 304, 306.

In an embodiment, the UE 106 may apply the acquired link-local IID as an UE identifier for the P2P discovery message within the network 308. As a result, the link-local IID assigned for ProSe purposes may act as a ProSe UE identifier as well. Since the identifier is unique under the serving network 308, the UE 106, which sent the discovery message, is addressable by using the detected/discovered ProSe identifier by the UE 108, for example. Thereafter, as indicated above, the UE 108 may perform at least one of the following: requesting a P2P communication connection to the UE corresponding to the detected link-local HD, transmitting a report indicating that a UE corresponding to the detected link-local HD has been discovered to be in proximity.

FIG. 7 shows an embodiment of the protocol stack with respect to the UE 106. The lowest layers in the stack may be formed by a radio layer and the link layer 720. A network layer 710 is above the link layer 720 and the application layer 700 is the highest layer in this example protocol stack. The application layer 700 may comprise different applications 704 and, as indicated, the existing ALDPs 702.

The network layer 710 may comprise sockets 712, such as link local (multicast) sockets generated by using the received link-local IID from the network 308 for example when establishing the link-local domain. The network layer 710 may further comprise the IP stack 714 and the neighbor discovery protocol (NDP) 716 for a neighbor IP node discovery. Messages of the NDP 716 may comprise a router solicitation. The UE 106 may apply the existing IPv6 address for such router solicitation message. The procedure may be as follows: the P-GW 116 of FIG. 1 sends the IPv6 prefix and IPv6 interface ID to the S-GW 114, and then the S-GW 114 forwards the IPv6 prefix and interface ID to the MME 112 or to an SGSN. The MME 112 or the SGSN forwards the IPv6 interface ID to the UE. The MME 112 does not forward the IPv6 prefix to the UE 106. Then the UE 106 may send a Router Solicitation message to the P-GW 116 to solicit a Router Advertisement message. The UE 106 may use the interface ID in the Router Solicitation message. The P-GW 116 may then send the Router Advertisement message (solicited or unsolicited) to the UE 106. The Router Advertisement messages shall contain the IPv6 prefix. Although, the acquired prefix may be usable for a neighbor discovery protocol which may be seen as link-local due to the link-local communication between the UE and the corresponding P-GW, it is not usable for multicast based P2P ProSe discovery, as indicated above.

The radio/link layer 720 may apply bearers 724, 726 and the established link-local P2P radio bearer 730. The default bearer 724 and the dedicated bearer 726 may be cellular bearers possibly requiring routing and, thus, the use of the IPv6 address with the routing prefix 200. However, owing the proposed link-local interface ID assigned to the UE 106, the UE 106 may apply the link-local P2P bearer to communicate, without routing, with the other UEs in proximity. The bearer 730 may be used for the multicast of discovery messages and for direct communication (unicast) with a specific UE in proximity. The radio/link layer 720 may also comprise a plurality of traffic flow template (TFT) filters 722. The TFT may be considered as a set of all packet filters associated with a given EPS bearer 724, 726 and 730, i.e. as a filter specification that describes the traffic flows in terms of IP addresses, protocols, port numbers, etc.

As explained, the UE 106 may, in an embodiment, have two interface identifiers: the IPv6 interface ID and the link-local, ProSe-specific, interface ID. The UE 106 may use these IDs as if the UE 106 had two network interfaces. Let us now look at how the UE 106 may use the different interface identifiers.

In an embodiment, the UE 106 may route link-local messages related to the neighbor discovery protocol to the corresponding P-GW 116 of the network 308, wherein the messages are configured with the IPv6 interface identifier. However, the UE 106 may route all other link-local messages over the established link-local P2P radio bearer, wherein the messages are configured with the acquired link local interface identifier. Thus, routing of the link local IP packets inside the UE 106 may follow the following principle: all other link local scope packets except the NDP messages, such as the Router Solicitation (in order to get a globally unique IPv6 prefix 200), shall use the link-local, ProSe specific interface identifier in the source address for the link-local communication. In other words, all other packets having link-local scope are sent through the established link-local P2P radio bearer 730, which may be seen as a link-local P2P discovery bearer (multicast/unicast) or as a link-local P2P communication bearer with a specific UE in proximity (unicast packet) using link-local IP addressing.

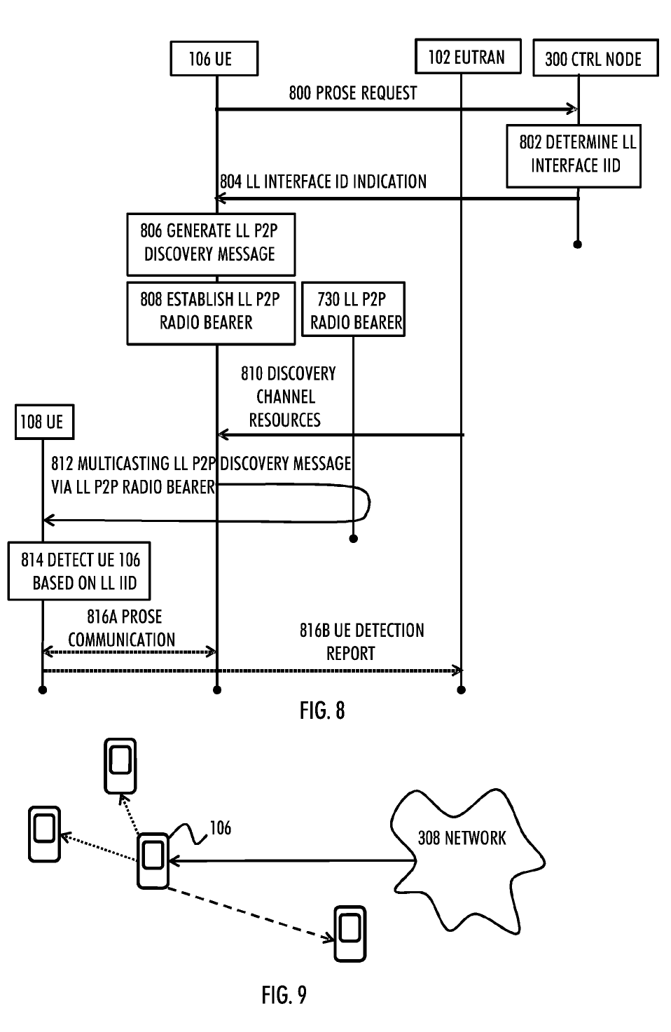

FIG. 8 illustrates the scenario in the form of a signaling flow diagram. In step 800, the UE 106 may transmit a ProSe request to the node of the network, such as to the control plane termination point 300. In case the node 300 detects the ProSe UE otherwise in the network, the step 800 may be omitted. In steps 802 and 804, the node 300 assigns a link-local IID to the UE 106. In steps 806 and 808, the UE 106 generates the link-local P2P discovery message by using the assigned link-local IID and establishes the link-local P2P radio bearer 730, respectively. Then, in step 810, the serving eNB 102 of the network 308 may allocate radio resources for the link-local P2P radio bearer 730. Then, in step 812, the UE 106 may transmit the link-local P2P discovery message in the proximity. The transmission may be multicasting. In step 814, the UE 108 in proximity detects the discovery message and the link-local IID in the discovery message. As indicated, this may enable the UE 108 to identify the UE 106 within the network 308. The UE 108 may then, for example, request/perform a P2P communication connection to the UE 106, as shown with a reference numeral 816A, and/or send a report to the network 308, as shown with a reference numeral 816B.

In an embodiment, functionality is configured in order to enable concurrent Local-Remote Peer (LRS) multicasting via local and cellular interfaces. It should be noted that, in a so called group communications, the ProSe UE 106 may have local and remote peers which share an application session. In such case, the network 308 may need to transmit the same message to each and every UE in the group. However, in this embodiment, it is proposed that the UE 106 receives at least one packet destined to the UE 106 itself and additionally to at least one remote and/or local peer. The UE 106 may duplicate the received at least one packet and deliver the at least one packet to one of the cellular bearers 728 and/or to the link-local P2P radio bearer 730, respectively. In other words, the UE 106 duplicates the detected application layer packet and delivers copies of the packet to both interfaces: to the conventional cellular bearer 730 (default or dedicated) and/or to the P2P discovery or communication bearer 730.

Thus, the network 308 may transmit the message only to the UE 106 instead of transmitting the same message to each and every UE in the group. This is shown in FIG. 9, where the network 308 transmits the group message to the UE 106 only. The UE 106 then forwards the message to the UEs in proximity via the P2P radio bearer, shown with dotted arrows. The UE 106 may also forward the message to the UE which is not in proximity but is in the target group via a cellular bearer, as shown with the dashed arrow.

In addition, in an embodiment, the UE 106 may be able to detect a multicast packet transmitted from the network 308 (via a cellular interface) and based on, e.g., the destination address, the UE 106 is able to transmit it further via the link-local P2P interface (i.e. radio bearer) and also deliver the packet to the application layer. Such automatic forward function may also be disabled so that the multicast-forwarding is processed first on the application layer. In such case the multicast packet is only forwarded to the corresponding application on the application layer, but not directly copied to the link-local interface. Only when application is configured in the UE 106, the UE 106 may additionally forward the message to the link-local interface.

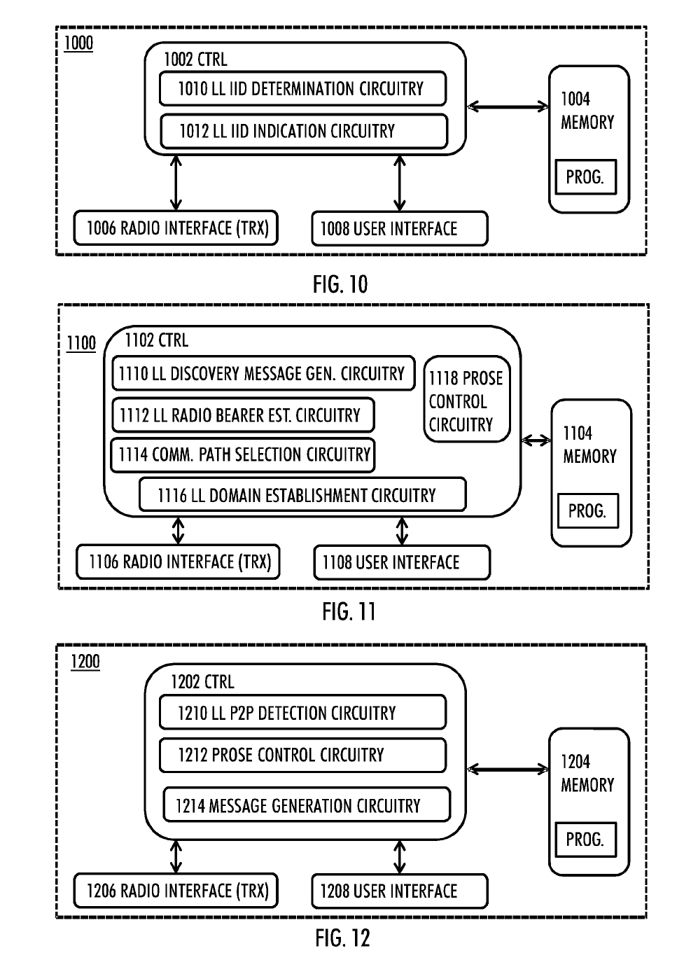

FIGS. 10 to 12 provide apparatuses 1000, 1100, and 1200 com-prising a control circuitry (CTRL) 1002, 1102, 1202, such as at least one processor, and at least one memory 1004, 1104, 1204 including a computer pro-gram code (PROG), wherein the at least one memory and the computer pro-gram code (PROG), are configured, with the at least one processor, to cause the respective apparatus 1000, 1100, 1200 to carry out any one of the embodiments described. It should be noted that FIGS. 10, 11, and 12 show only the elements and functional entities required for understanding a processing systems of the apparatuses. Other components have been omitted for reasons of simplicity. It is apparent to a person skilled in the art that the apparatuses may also comprise other functions and structures.

Each of the apparatuses 1000, 1100, 1200 may, as indicated, comprise a control circuitry 1002, 1102, 1202, respectively, e.g. a chip, a processor, a micro controller, or a combination of such circuitries causing the respective apparatus to perform any of the embodiments of the invention. Each control circuitry may be implemented with a separate digital signal processor provided with suitable software embedded on a computer readable medium, or with a separate logic circuit, such as an application specific integrated circuit (ASIC). Each of the control circuitries may comprise an interface, such as computer port, for providing communication capabilities. The respective memory 1004, 1104, 1204 may store software (PROG) executable by the corresponding at least one control circuitry

The apparatuses 1000, 1100, 1200 may further comprise radio interface components (TRX) 1006, 1106, 1206 providing the apparatus with radio communication capabilities with the radio access network. The radio inter-face components may comprise standard well-known components such as amplifier, filter, frequency-converter, (de)modulator, and encoder/decoder circuitries and one or more antennas.

The apparatuses 1000, 1100, 1200 may also comprise user inter-faces 1008, 1108, 1208 comprising, for example, at least one keypad, a micro-phone, a touch display, a display, a speaker, etc. Each user interface may be used to control the respective apparatus by the user.

As indicated, the apparatuses 1000, 1100, 1200 may comprise the memories 1004, 1104, 1204 connected to the respective control circuitry 1002, 1102, 1202. However, memory may also be integrated to the respective control circuitry and, thus, no separate memory may be required. The memory may be implemented using any suitable data storage technology, such as semiconductor based memory devices, flash memory, magnetic memory devices and systems, optical memory devices and systems, fixed memory and removable memory.

In an embodiment, the apparatus 1000 may be or be comprised in a base station (also called a base transceiver station, a Node B, a radio network controller, or an evolved Node B, for example). In an embodiment, the apparatus 1000 is or is comprised in the control point termination node 300 of the network 308.

The control circuitry 1002 may comprise a link-local determination circuitry 1010 for determining the link-local interface ID to be assigned to the UE. A link-local interface ID indication circuitry 1012 may perform the indication of the link-local IID to the UE.

In an embodiment, the apparatus 1100 may comprise the terminal device of a cellular communication system, e.g. a UE, a UT, a computer (PC), a laptop, a tabloid computer, a cellular phone, a communicator, a smart phone, a palm computer, or any other communication apparatus. Alternatively, the apparatus 1100 is comprised in such a terminal device. Further, the apparatus 1100 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 1100 may be, comprise or be comprised in a mobile phone, such as the UE 106, operating according to the long term evolution or according to the long term evolution advanced.

The control circuitry 1102 may comprise a link-local P2P discovery message generation circuitry 1110 for generating the link-local P2P discovery message. A link-local P2P radio discovery bearer establishment circuitry 1112 may be for establishing the radio bearer 730. A communication path selection circuitry 1114 may be for selecting the correct path for link-local scope packets (e.g. to route the packet via the cellular bearer 728 or via the P2P bearer 730). A link-local domain establishment circuitry 1116 may be for setting up the link-local domain between at least one UE and the apparatus 1100. A ProSe control circuitry 1118 may be for performing functionalities relating to the proximity services, such as P2P transmitting/detecting discovery messages and/or communicating directly with another UE (P2P communication).

In an embodiment, the apparatus 1200 may comprise the terminal device of a cellular communication system, e.g. a user equipment (UE), a user terminal (UT), a computer (PC), a laptop, a tabloid computer, a cellular phone, a communicator, a smart phone, a palm computer, or any other communication apparatus. Alternatively, the apparatus 1200 is comprised in such a terminal device. Further, the apparatus 1200 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 1200 may be, comprise or be comprised in a mobile phone, such as the UE 108, operating according to the long term evolution or according to the long term evolution advanced.

The control circuitry 1202 may comprise a link-local P2P discovery message detection circuitry 1210 for detecting link-local P2P discovery messages. A ProSe control circuitry 1212 may be for performing functionalities relating to the proximity services, such as P2P transmitting/detecting discovery messages, communicating directly with another UE (P2P communication), and/or transmitting report to the network. A message generation circuitry 1214 may be for generating an IPv6 message for application layers based on the detected link-local interface ID.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method for enabling peer discovery in a mobile communications network, comprising:
detecting, by a node of a network, that a user equipment connected to the network is capable of performing peer-to-peer (P2P) proximity services;
determining a link-local interface identifier to be assigned to the detected user equipment, wherein the determined link-local interface identifier is unique within the network; and
causing an indication of the assigned link-local interface identifier to the detected user equipment in order to enable the user equipment to establish a link-local domain with at least one other user equipment in the network.

2. The method of claim 1, further comprising:
obtaining an indication from the user equipment in which the user equipment indicates the capability to perform the P2P proximity services.

3. The method of claim 1, further comprising:
indicating the link-local interface identifier in one of the following ways: as a separate signaling during the attach procedure of the user equipment to the network, as a separate signaling after the attach procedure of the user equipment to the network, as an additional signaling during a handover from the network to another network.

4. The method of claim 1, further comprising:
dedicating the assigned link-local interface identifier to be used by the user equipment for the P2P proximity services, wherein the P2P proximity services comprise transmission of a P2P discovery message and/or performing a P2P communication with the at least one other user equipment.

5. The method of claim 1, wherein the network is a specific public land mobile network.

6. The method of claim 1, wherein the node is one of the following: a control plane termination node of the network, an entity responsible of the proximity services in the network, a mobility management entity of the network.

7. A method for enabling P2P communications in a mobile communications network, comprising:
acquiring, by a user equipment capable of performing P2P proximity services, a link-local interface identifier from a node of a network, wherein the link-local interface identifier is unique within the network; and
establishing a link-local domain with at least one other user equipment in the network at least partly on the basis of the acquired link-local interface identifier.

8. The method of claim 7, further comprising:
generating a link-local P2P discovery message at least partly on the basis of an application layer discovery protocol and the acquired link-local interface identifier;
establishing a link-local P2P radio bearer between the user equipment and at least one other user equipment; and
transmitting the link-local P2P discovery message over the link-local P2P radio bearer to the at least one other user equipment.

9. The method of claim 8, further comprising:
including the link-local interface identifier to the link-local P2P discovery message as a source address.

10. The method of claim 8, further comprising:
receiving a request to establish a direct link-local P2P connection with a specific user equipment which detected the link-local P2P discovery message;
establishing the direct link-local P2P connection to the specific user equipment; and
transmitting user data over the established direct link-local P2P connection to the specific user equipment.

11. The method of claim 8, further comprising:
obtaining an internet protocol version 6, IPv6, interface identifier;
routing link-local messages related to a neighbor discovery protocol to a packet data network gateway of the network, wherein the messages are configured with the IPv6 interface identifier; and
routing all other link-local messages over the established link-local P2P radio bearer, wherein the messages are configured with the link local interface identifier.

12. The method of claim 8, further comprising:
receiving at least one packet destined to the user equipment and to at least one remote and/or local peer;
duplicating the received at least one packet; and
delivering the at least one packet to a cellular bearer and/or to the link-local P2P radio bearer, respectively.

13. The method of claim 7, further comprising:
receiving an indication according to which the acquired link-local interface identifier is dedicated to be used for the P2P proximity services in the network, wherein the P2P proximity services comprise transmission of a P2P discovery message and/or performing a P2P communication with the at least one other user equipment.

14. A method for enabling P2P communications in a mobile communications network, comprising:
detecting, by a user equipment capable of performing P2P proximity services, a link-local P2P discovery message sent by another user equipment, wherein the link-local P2P discovery message is at least partly based on an application layer discovery protocol; and
detecting a link-local interface identifier included in the link-local P2P discovery message, wherein the link-local interface identifier is unique within a serving network.

15. The method of claim 14, further comprising:
performing at least one of the following: requesting a P2P communication connection to the user equipment corresponding to the detected link-local interface identifier, transmitting a report indicating that the user equipment corresponding to the detected link-local interface identifier has been discovered to be in proximity.

16. The method of claim 14, further comprising:
generating an internet protocol version 6, IPv6, message on the basis of the detected link-local interface identifier and a predetermined criterion; and
processing the generated IPv6 message in an application layer.

17-39. (canceled)
